(19) United States
(12) Patent Application Publication
(10) Pub. No.: US 2003/0103314 A1
(43) Pub. Date: Jun. 5, 2003

(54) Static-electricity absorbing mat for access floors

(76) Inventor: Moon Soo Lee, Seoul-shi (KR)

Correspondence Address: STAAS & HALSEY LLP, 700 11TH STREET, NW, SUITE 500, WASHINGTON, DC, 20001, US

(21) Appl. No.: 10/303,021

(22) Filed: Nov. 25, 2002

(30) Foreign Application Priority Data
Nov. 26, 2001 (KR) 2001-36355
Nov. 19, 2002 (KR) 2002-34505

(51) Int. Cl. H02H 1/00

(52) U.S. Cl. 361/220

(57) ABSTRACT

Disclosed is a static-electricity absorbing mat for access floors which is attached to the upper side of the access floors, each structured such that cables including electrical lines and communication lines are positioned throughout channels at the underside of the access floor. The mat comprises an insulating resin layer constituting the upper part of the static-electricity absorbing mat, and a conductive sheet integrally attached to the underside of the insulating resin layer. Furthermore, the mat has advantages of low construction cost and securing a static-electricity preventing effect without worry of scratching or staining.

### BACKGROUND OF THE INVENTION

1. Field of the Invention

The present invention relates, in general, to static-electricity absorbing mats and, in particular, to a static-electricity absorbing mat for access floors which is attached to the upper side of the access floors, each structured such that cables, such as electrical lines and communication lines, are positioned throughout channels at the underside of the access floor.

2. Description of the Prior Art

As well known to those skilled in the art, conventional various synthetic resin floor plates (hereinafter, referred to as “access floors”) are on the market, which are assembled on the floors of a building so as to desirably hide cables such as electrical lines and communication lines and aid to control temperature and humidity in a room. One example of such is disclosed in Korean Utility Model No. 1996-7953 (Laid-Open Publication No.: 1995-11784).

The access floor generally is made of resins with high strength such as PVC (polyvinyl chloride), and is popular in the art because of its ease of application to the floor of a building.

A commercial access floor has a width and length of 20 cm or so and height of 6 cm or so, and so tens to hundreds of access floors are required to be installed in a building.

Because a plurality of access floors are constructed on each floor of a building, a mat, such as a sheet or tile (hereinafter, referred to as “mat”), or a carpet, is used to cover access floors. Generally, furniture is positioned on the mat or carpet.

Meanwhile, cables, such as electrical lines, communication lines such as telephone wires, and data transmission lines, are positioned throughout channels at the underside of each access floor, and so static-electricity may occur on the surface of the access floor due to electromagnetic waves induced from cables. To avoid this, a static-electricity absorbing mat is used to cover the access floor to absorb or intercept the static-electricity.

Examples of conventional static-electricity absorbing mats include a carbon-mixed sheet in which carbon is incorporated in resin (Korean Utility Model No. 1987-2585), and a surfactant-mixed sheet in which a surfactant is incorporated in resin. In these cases, carbon or surfactant is mixed with synthetic resin chips, heated, and pressed by a roller to produce the carbon-mixed sheet or the surfactant-mixed sheet. At this time, the carbon-mixed sheet and the surfactant-mixed sheet are characterized in that a conductive material (carbon or surfactant) with electric resistance is incorporated into a resin to make the resin have conductive property. The resulting conductive resin absorbs the static-electricity and reemits the static-electricity in a form of heat or grounds the static-electricity. Hereinafter, this type of conductive resin is referred to as “conductive-body-mixed sheet”.

However, the carbon-mixed sheet is disadvantageous in that its surface is readily stained because it contains black carbon. Additionally, the surfactant-mixed sheet has a disadvantage of contamination of its surface because the surfactant flows out to its surface. Further, structures of these conductive-body-mixed sheets are softened because of containing conductive materials, so their surfaces are readily scratched.

Furthermore, it is difficult to attach theses sheets to the access floor even using an adhesive because carbon or surfactant particles protruded on surfaces of sheets cause these surfaces to be uneven.

### SUMMARY OF THE INVENTION

Therefore, the present invention has been made keeping in mind the above disadvantages occurring in the prior art, and an object of the present invention is to provide a static-electricity absorbing mat for access floors which has improved surface hardness and a static-electricity preventing effect, without staining it's own surface.

It is another object of the present invention to provide a static-electricity absorbing mat for access floors which has excellent adhesion to the access floors.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partial perspective view, partly broken away to show the interior construction of a static-electricity absorbing mat for access floors according to an embodiment of the present invention;

FIG. 2 is a partial perspective view, partly broken away to show the interior construction of a static-electricity absorbing mat for access floors according to another embodiment of the present invention; and

FIG. 3 is a partial perspective view, partly broken away to show the interior construction of a static-electricity absorbing mat for access floors according to still another embodiment of the present invention.

### DETAILED DESCRIPTION OF THE INVENTION

According to the present invention, a static-electricity absorbing mat for access floors which is attached to upper sides of the access floors, each structured such that cables including electrical lines and communication lines are positioned throughout channels at the underside of the access floor, is characterized in that the static-electricity absorbing mat comprises an insulating resin layer constituting an upper part of the static-electricity absorbing mat, and a conductive sheet integrally attached to the lower side of the insulating resin layer.

At this time, the insulating resin layer preferably comprises polyvinyl chloride.

Useful, as the conductive sheet in the present invention, may be a carbon-coated sheet produced by coating carbon on either one or both sides of a thin synthetic resin film.

Further, the conductive sheet may be a polyvinyl chloride sheet containing carbon. In this case, it is preferable that a carbon-coated sheet produced by coating carbon on either one or both sides of a thin synthetic resin film is additionally united with the underside of the polyvinyl chloride sheet containing carbon.

Furthermore, the conductive sheet may be a polyvinyl chloride sheet containing a surfactant. At this time, it is preferable that a carbon-coated sheet produced by coating carbon on either one or both sides of a thin synthetic resin film is additionally united with the underside of the polyvinyl chloride sheet containing the surfactant.

Reference should now be made to the drawings, in which the same reference numerals are used throughout the different drawings to designate the same or similar components.

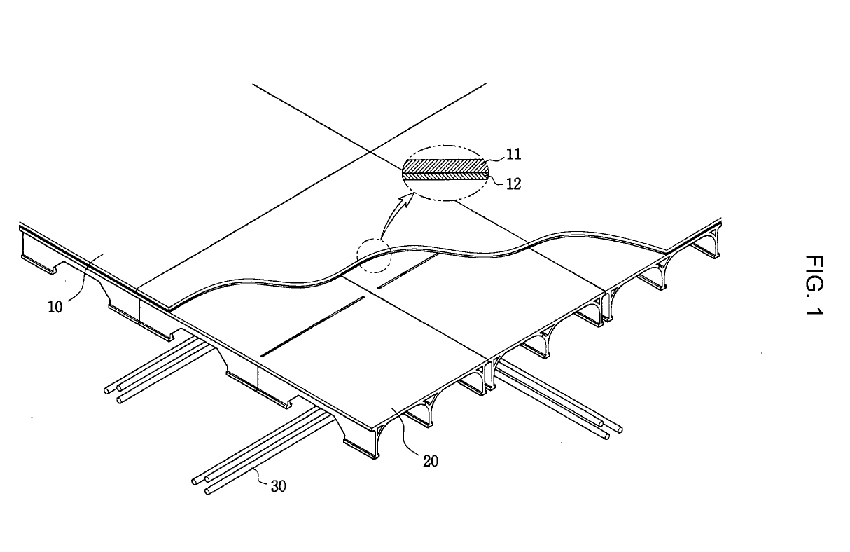

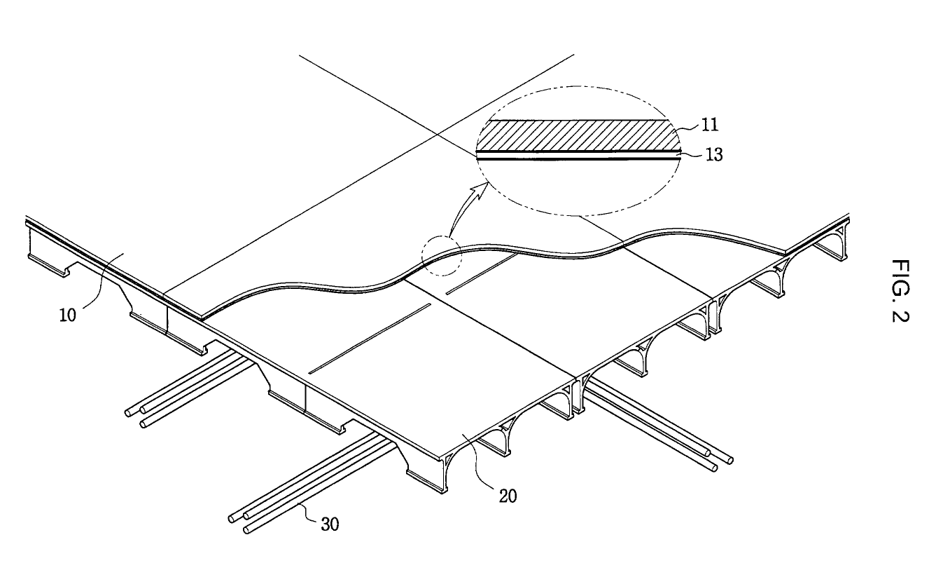

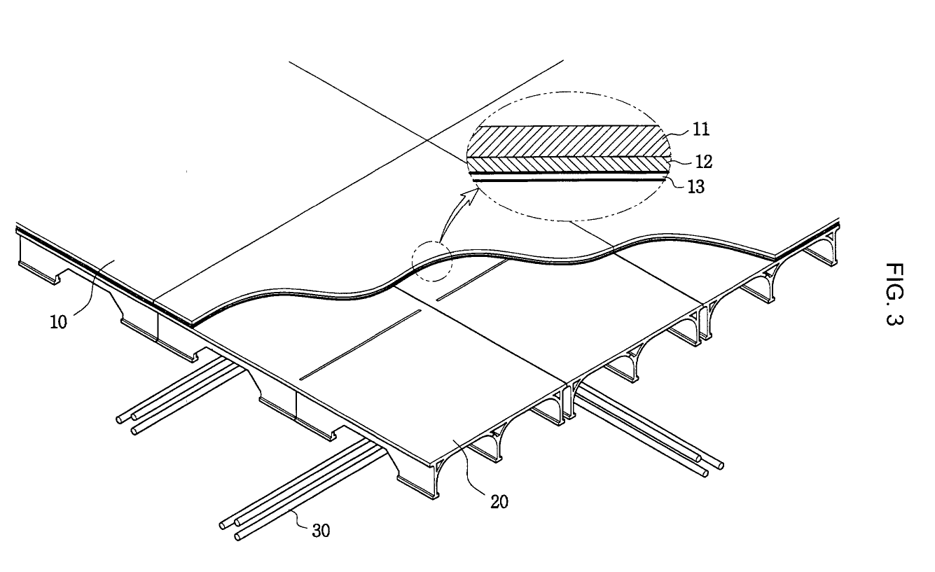

FIG. 1 is a partial perspective view, partly broken away to show the interior construction of a static-electricity absorbing mat for access floors according to an embodiment of the present invention, FIG. 2 is a partial perspective view, partly broken away to show the interior construction of a static-electricity absorbing mat for access floors according to another embodiment of the present invention, and FIG. 3 is a partial perspective view, partly broken away to show the interior construction of a static-electricity absorbing mat for access floors according to still another embodiment of the present invention.

With reference to FIG. 1, a plurality of access floors 20 are assembled on a concrete bottom without a separate duct, and cables 30, such as electrical lines and communication lines, are positioned between the concrete floor and access floors 20. This method of constructing the access floors 20 on the concrete bottom has advantages of low construction cost, ease of construction, and allowing neat arranging of cables in computer rooms, offices, and laboratories.

The mat 10 according to the present invention is attached to the access floors 20, as shown in FIG. 1.

In FIG. 1, a reference numeral 12 denotes a conductive-body-mixed sheet. The conductive-body-mixed sheet 12 preferably consists of PVC containing carbon or surfactant. The reason for this is that it is most preferable that an insulating resin layer 11 consists of PVC.

As in FIG. 1, the insulating resin layer 11, consisting of an insulating synthetic resin sheet with thickness of 1.5 mm, is attached to the conductive-body mixed sheet 12 with thickness of 0.5 mm, by a heat-compression process.

When the conductive-body mixed resin 12 with surface electric resistance of 10⁹ Ω/cm² or lower is integrally attached to the underside of the non-conductive insulating resin layer 11, the surface electric resistance of the insulating resin layer 11 is reduced to 10¹³ Ω/cm² or lower due to a tunneling effect. As will be appreciated by those skilled in the art, if the surface electric resistance is 10¹³ Ω/cm² or lower, it is sufficient to prevent the transmission of static-electricity. For reference, according to US military spec., an anti-static grade ranges from 10⁹ Ω/cm² to 10¹⁴ Ω/cm².

Accordingly, when the conductive-body-mixed sheet 12 such as the carbon-mixed sheet or the surfactant-mixed sheet is used as the conductive sheet of the present invention, it is preferable that the surface resistance of the conductive sheet is controlled to a range of 10⁶ Ω/cm² to 10⁹ 2/cm².

Referring to FIG. 2, the carbon-coated sheet 13 is used as the conductive sheet. The carbon-coated sheet 13 is produced by printing or coating carbon powder on either one or both sides of a thin synthetic resin film. The surface resistance of the carbon-coated sheet is readily reduced to 10⁶ Ω/cm² to 10⁹ Ω/cm² by controlling the thickness of the carbon layer coated on the thin synthetic resin film. Whether the surface of the thin synthetic resin film is coated with the carbon powder or not, the carbon-coated sheet 13 is readily attached to the access floor using an adhesive. A conventional carbon sheet containing carbon or a surfactant sheet containing surfactant includes the synthetic resin and conductive materials (carbon or surfactant), thus forming a plurality of small-sized protuberances on the sheet surface, causing the adhesion of the sheet to the access floor to be poor. On the other hand, in the case of the carbon-coated sheet according to the present invention, its surface consists of a single material, for example only carbon or only synthetic resin, thus it is smooth and has excellent adhesive strength.

Turning now to FIG. 3, the conductive-body-mixed sheet 12 is integrally attached to the underside of the insulating resin layer 11, and the carbon-coated sheet 13 is integrally attached to the underside of the conductive-body-mixed sheet 12. This structure functions to reinforce static-electricity absorbility of the conductive-body-mixed sheet 12 and reduce the amount of the conductive body incorporated in the conductive-body-mixed sheet 12 to prevent the conductive-body-mixed sheet from being excessively softened. Further, the structure allows the mat to be readily attached to the access floor. As described above, when the carbon-coated sheet 13 is attached to the access floor, the resulting structure has excellent static-electricity absorption and adhesion to the access floor.

The insulating resin layer 11, constituting an upper part of the mat according to the present invention, has a general surface electric resistance value of the synthetic resin sheet, 10¹⁴ Ω/cm² or higher, before the insulating resin layer 11 is integrally attached to the conductive sheet 12. However, when the conductive sheet with a surface resistance of 10⁹ Ω/cm² or lower is integrally attached to the insulating resin layer 11, the resulting structure forms an anti-static layer with a surface resistance of 10¹⁰ Ω/cm² to 10¹³ Ω/cm². The anti-static layer mostly shields static-electricity induced by friction or electromagnetic waves.

Therefore, the conductive sheet, constituting a lower part of the static-electricity absorbing mat for the access floor according to the present invention, shields electromagnetic waves induced from cables, such as electrical lines and communication lines, to prevent induced static-electricity from occurring on the mat surface, and maintains the surface resistance of the mat surface to an anti-static resistance value to prevent static-electricity induced due to surface friction.

The insulating resin layer 11 and the conductive sheet 12 or 13 may consist of any synthetic resin, but it is preferable to use only PVC. The reason the insulating resin layer 11 and the conductive sheet 12 or 13 should consist of a single material is that strength of the insulating resin layer 11 is readily improved, and adhesive strength between the insulating resin layer 11 and the conductive sheet 12 or 13 is excellent. Additionally, because the access floor is also made of PVC, the insulating resin layer 11 and the conductive sheet 12 or 13 readily adhere to the access floor if the insulating resin layer 11 and the conductive sheet 12 or 13 are all made of PVC. Accordingly, the present invention provides the static-electricity absorbing mat with high surface strength and provides it with excellent adhesion to the access floor.

As described above, the present invention is advantageous in that a static-electricity absorbing mat is provided which is integrally attached to access floors each structured such that cables, such as electrical lines and communication lines, which induce static-electricity, are positioned throughout channels at the underside of the access floor, thereby securing low construction cost of the mat and preventing transmission of static-electricity without worrying about scratching or staining. Another advantage is that the static-electricity absorbing mat of the present invention has excellent adhesive strength to the access floor.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A static-electricity absorbing mat for access floors, which is attached to the upper side of the access floors, each structured such that cables including electrical lines and communication lines are positioned throughout channels at an underside of the access floor, comprising:
an insulating resin layer constituting an upper part of the static-electricity absorbing mat; and
a conductive sheet integrally attached to a lower side of the insulating resin layer.

2. The static-electricity absorbing mat according to claim 1, wherein the insulating resin layer comprises polyvinyl chloride.

3. The static-electricity absorbing mat according to claim 1 or 2, wherein the conductive sheet is a carbon-coated sheet produced by coating carbon on either one or both sides of a thin synthetic resin film.

4. The static-electricity absorbing mat according to claim 1 or 2, wherein the conductive sheet is a polyvinyl chloride sheet containing carbon.

5. The static-electricity absorbing mat according to claim 4, wherein a carbon-coated sheet produced by coating carbon on either one or both sides of a thin synthetic resin film is additionally united with a lower side of the polyvinyl chloride sheet containing carbon.

6. The static-electricity absorbing mat according to claim 1 or 2, wherein the conductive sheet is a polyvinyl chloride sheet containing a surfactant.

7. The static-electricity absorbing mat according to claim 6, wherein a carbon-coated sheet produced by coating carbon on either one or both sides of a thin synthetic resin film is additionally united with a lower side of the polyvinyl chloride sheet containing the surfactant.
